(19) United States
(12) Patent Application Publication
(10) Pub. No.: US 2019/0220294 A1
(43) Pub. Date: Jul. 18, 2019

(54) USING LIGHTWEIGHT JIT COMPILATION FOR SHORT-LIVED JVMS ON PARALLEL DISTRIBUTING COMPUTING FRAMEWORK

(71) Applicant: INTERNATIONAL BUSINESS MACHINES CORPORATION, Armonk, NY (US)

(72) Inventors: Michihiro Horie, Saitama (JP); Kazunori Ogata, Tokyo (JP); Takeshi Yoshimura, Tokyo (JP)

(21) Appl. No.: 15/873,594

(22) Filed: Jan. 17, 2018

(51) Int. Cl. G06F 9/455; G06F 8/41

(52) U.S. Cl. CPC G06F 9/4552; G06F 8/443; G06F 9/45533

(57) ABSTRACT

A computer-implemented method and computer program product are provided for restarting a virtual machine for processing each of a plurality of jobs in a parallel distributed computing framework. The method includes estimating whether or not the virtual machine is short-lived, by using multiple criteria obtainable from metadata. The multiple criteria includes a number of workload columns, a number of workload splits, and a size of data types corresponding to the virtual machine. The method further includes restarting the virtual machine with a configuration of using only a lightweight Just In Time compilation by specifying its virtual machine argument, responsive to the virtual machine being estimated as short-lived.

### BACKGROUND

### Technical Field

The present invention relates generally to information processing and, in particular, to using a lightweight JIT compilation for short-lived JVMs on a parallel distributing computing framework.

### Description of the Related Art

When a parallel distributed computing framework such as Spark® or MapReduce is used, some Java Virtual Machines (JVMs) finish in a very short period (a few seconds).

Just In Time (JIT) compilation in the Open Java Development Kit (OpenJDK) has four compilation levels. A higher level of JIT compilation generates faster code but takes more time. The four compilation levels are as follows:

Level 1: lightweight compilation without profiling.
Level 2: lightweight compilation with lightweight profiling.
Level 3: lightweight compilation with heavyweight profiling.
Level 4: heavyweight compilation by using the profiling result taken at Level 2 or 3.

Execution path with (I) Interpreter (II) Level 3, and (III) Level 4 is the default setting in OpenJDK.

When a Java Virtual Machine (JVM®) is short-lived, the time spent for the compilation becomes in vain due to the situation that methods are compiled but not frequently invoked after the compilation.

In general, it is quite difficult to decide whether a JVM® is short-lived in advance.

An existing prior art technique involves reusing JVMs for executing jobs. However, it is possible that continuously reusing JVMs degrades performance due to decreasing the buffer cache. Hence, there is a need for an approach that uses lightweight JIT compilation for short-lived JVMs on a parallel distributed computing framework.

### SUMMARY

According to an aspect of the present invention, a computer-implemented method is provided for restarting a virtual machine for processing each of a plurality of jobs in a parallel distributed computing framework. The method includes estimating whether or not the virtual machine is short-lived, by using multiple criteria obtainable from metadata. The multiple criteria includes a number of workload columns, a number of workload splits, and a size of data types corresponding to the virtual machine. The method further includes restarting the virtual machine with a configuration of using only a lightweight Just In Time compilation by specifying its virtual machine argument, responsive to the virtual machine being estimated as short-lived.

According to another aspect of the present invention, a computer program product is provided for restarting a virtual machine for processing each of a plurality of jobs in a parallel distributed computing framework. The computer program product includes a non-transitory computer readable storage medium having program instructions embodied therewith. The program instructions are executable by a computer to cause the computer to perform a method. The method includes estimating whether or not the virtual machine is short-lived, by using multiple criteria obtainable from metadata. The multiple criteria include a number of workload columns, a number of workload splits, and a size of data types corresponding to the virtual machine. The method further includes restarting the virtual machine with a configuration of using only a lightweight Just In Time compilation by specifying its virtual machine argument, responsive to the virtual machine being estimated as short-lived.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 shows an exemplary processing system to which the present invention may be applied, in accordance with an embodiment of the present invention;

FIG. 2 is a block diagram showing an exemplary environment to which the present invention can be applied, in accordance with an embodiment of the present invention; and

FIG. 3 shows an exemplary method for restarting a Java Virtual Machine (JVM®) for processing each of a plurality of jobs in a parallel distributed computing framework, in accordance with an embodiment of the present invention.

### DETAILED DESCRIPTION

The present invention is directed to using a lightweight JIT compilation for short-lived JVMs on a parallel distributing computing framework.

In an embodiment, the present invention chooses a policy of lightweight JIT compilation based on the JVM lifetime. For example, in an embodiment, in a parallel distributed computing framework that restarts a JVM each time for processing each job, only lightweight JIT compilation (Level 1) is conducted against short-lived JVMs.

It is to be appreciated that while one or more embodiments of the present invention are described with respect to a Java Virtual Machine (JVM), the present invention can be applied to other virtual machines that use multiple levels of compilation, as readily appreciated by one of ordinary skill in the art given the teachings of the present invention provided herein, while maintaining the spirit of the present invention.

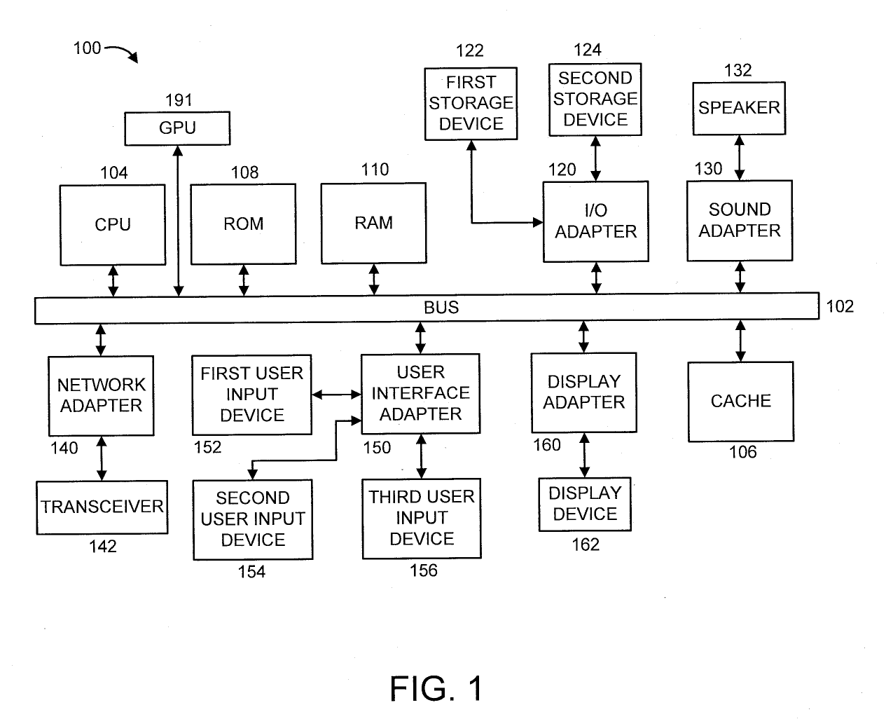

FIG. 1 shows an exemplary processing system 100 to which the invention principles may be applied, in accordance with an embodiment of the present invention. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102. At least one Graphics Processing Unit (GPU) 191 is operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

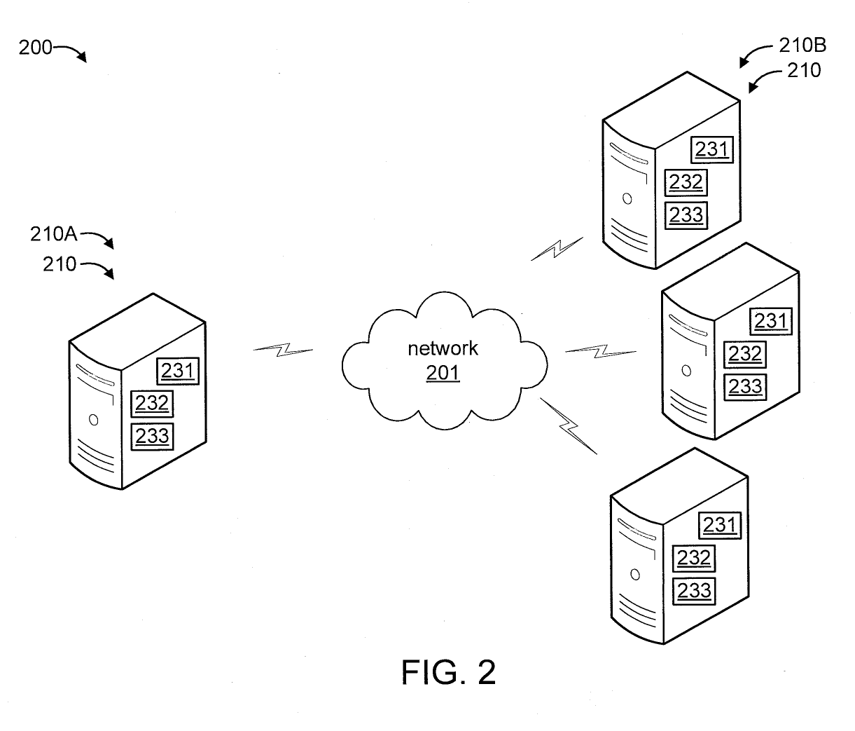

Moreover, it is to be appreciated that environment 200 described below with respect to FIG. 2 is an environment for implementing respective embodiments of the present invention. Part or all of processing system 100 may be implemented in one or more of the elements of environment 200.

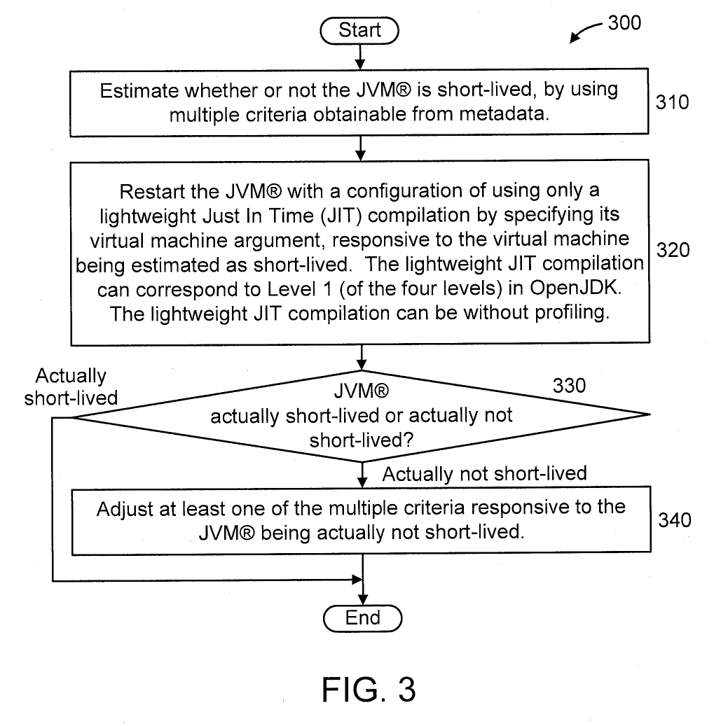

Further, it is to be appreciated that processing system 100 may perform at least part of the method described herein including, for example, at least part of method 300 of FIG. 3. Similarly, part or all of environment 200 may be used to perform at least part of method 300 of FIG. 3.

FIG. 2 is a block diagram showing an exemplary environment 200 to which the present invention can be applied, in accordance with an embodiment of the present invention. The environment 200 is representative of a parallel distributed computing framework to which the present invention can be applied. The parallel distributed computing framework can be, but is not limited to, Spark®, MapReduce, and so forth. The elements shown relative to FIG. 2 are set forth for the sake of illustration. However, it is to be appreciated that the present invention can be applied to other configurations and other operational environments as readily contemplated by one of ordinary skill in the art given the teachings of the present invention provided herein, while maintaining the spirit of the present invention.

The environment 200 at least includes multiple computing nodes 210 connected in a parallel distributed computing framework. The multiple computing nodes 210 form a cluster 299 of machines. In an embodiment, in the cluster 299, one of the computing nodes 210 can act as a master 210M, while other ones of the computing nodes can act as slaves 210S. In an embodiment, each of the computing nodes 210 can include one or more servers or other computing machines.

Each of the computing nodes 210 can at least include a processing element 231, a memory 232, and a communication device 233. The communication device 233 can be, for example, but is not limited to, a wireless transceiver, an Ethernet adapter, a Network Interface Card (NIC), and so forth.

Each of the computing nodes 210 is configured to implement the present invention, namely use lightweight JIT compilation for short-lived JVMs on a parallel distributing computing framework.

In the embodiment shown in FIG. 2, the elements thereof are interconnected by a network(s) 201. However, in other embodiments, other types of connections can also be used. Additionally, one or more elements in FIG. 2 may be implemented by a variety of devices, which include but are not limited to, Digital Signal Processing (DSP) circuits, programmable processors, Application Specific Integrated Circuits (ASICs), Field Programmable Gate Arrays (FPGAs), Complex Programmable Logic Devices (CPLDs), and so forth. These and other variations of the elements of environment 200 are readily determined by one of ordinary skill in the art, given the teachings of the present invention provided herein, while maintaining the spirit of the present invention.

FIG. 3 shows an exemplary method 300 for restarting a Java Virtual Machine (JVM®) for processing each of a plurality of jobs in a parallel distributed computing framework, in accordance with an embodiment of the present invention.

At step 310, estimate whether or not the JVM® is short-lived, by using multiple criteria obtainable from metadata.

The multiple criteria can include, but is not limited to, for example: a number of columns; a number of splits; a size of data types; an operator of queries on the JVM®; a number of executing threads on the JVM®; a frequency of garbage collection on the virtual machine; one or more settings of the parallel distributed computing framework; hardware configurations (e.g., the number of hardware threads, the size of system RAM, and so forth. The one or more settings of the parallel distributed computing framework can include, but are not limited to, for example: whether or not a thrift server is used; whether or not query optimizations with code generations (e.g., whole stage code generation in Apache® Spark®) are enabled; whether or not a cluster resource manager (e.g., Apache® Hadoop® YARN and Apache® Mesos®) restricts the JVM® lifetime and/or computing resources of the parallel distributed computing framework; the version and type of JVM® runtime (e.g., OpenJDK or IBM® Java®); whether or not the parallel distributed computing runs on top of virtualized environments; input storage types (e.g., distributed/local file systems, database systems, and cloud object storage); and so forth. The number of columns can correspond to, for example, an output table from the JVM® or a table that is processed by the JVM®. The output table can include, for example, monitored statistics and/or so forth. The number of splits can correspond to, for example, the number of splits of a workload or input processed by the JVM®. The size of data types can correspond to the various different data types (e.g., boolean, byte, char, short, int, long, float, double) to be processed by the JVM®.

At step 320, restart the JVM® with a configuration of using only a lightweight Just In Time (JIT) compilation by specifying its virtual machine argument, responsive to the virtual machine being estimated as short-lived. In an embodiment, the lightweight JIT compilation can correspond to Level 1 (of the four levels) in OpenJDK. Hence, in an embodiment, the lightweight JIT compilation can be without profiling. It is again noted that the default setting in OpenJDK is an Execution path with (I) Interpreter (II) Level 3, and (III) Level 4.

At step 330, check whether the JVM® that is once estimated as short-lived is actually short-lived or actually not short-lived after execution of the virtual machine. If the JVM® is actually short-lived, then terminate the method. Otherwise (if the JVM® is actually not short-lived), then proceed to step 340.

At step 340, adjust at least one of the multiple criteria responsive to the JVM being actually not short-lived.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method for restarting a virtual machine for processing each of a plurality of jobs in a parallel distributed computing framework, the method comprising:
estimating whether or not the virtual machine is short-lived, by using multiple criteria obtainable from metadata, the multiple criteria including a number of workload columns, a number of workload splits, and a size of data types corresponding to the virtual machine; and
restarting the virtual machine with a configuration of using only a lightweight Just In Time compilation by specifying its virtual machine argument, responsive to the virtual machine being estimated as short-lived.

2. The computer-implemented method of claim 1, wherein the virtual machine is a Java Virtual Machine.

3. The computer-implemented method of claim 1, further comprising:
checking whether the virtual machine that is once estimated as short-lived is actually short-lived or actually not short-lived after execution of the virtual machine; and
adjusting at least one of the multiple criteria responsive to the virtual machine being actually not short-lived.

4. The computer-implemented method of claim 1, wherein the multiple criteria further include an operator of queries on the virtual machine.

5. The computer-implemented method of claim 1, wherein the multiple criteria further include a number of executing threads on the virtual machine.

6. The computer-implemented method of claim 1, wherein the multiple criteria further include one or more settings of the parallel distributed computing framework.

7. The computer-implemented method of claim 6, wherein the one or more settings of the parallel distributed computing framework include whether or not a thrift server is used.

8. The computer-implemented method of claim 1, wherein the lightweight Just In Time compilation is without profiling.

9. The computer-implemented method of claim 1, wherein the lightweight Just In Time compilation is selected from a plurality of Just In Time compilation levels.

10. The computer-implemented method of claim 9, wherein each of the plurality of Just In Time compilation levels correspond to a respective one of a plurality of compilation levels, the plurality of compilation levels requiring more compilation time with each increasing one of the plurality of levels, and wherein the lightweight Just In Time compilation that is selected corresponds to a lowest one of the plurality of compilation levels.

11. A computer program product for restarting a virtual machine for processing each of a plurality of jobs in a parallel distributed computing framework, the computer program product comprising a non-transitory computer readable storage medium having program instructions embodied therewith, the program instructions executable by a computer to cause the computer to perform a method comprising:
estimating whether or not the virtual machine is short-lived, by using multiple criteria obtainable from metadata, the multiple criteria including a number of workload columns, a number of workload splits, and a size of data types corresponding to the virtual machine; and
restarting the virtual machine with a configuration of using only a lightweight Just In Time compilation by specifying its virtual machine argument, responsive to the virtual machine being estimated as short-lived.

12. The computer program product of claim 11, wherein the virtual machine is a Java Virtual Machine.

13. The computer program product of claim 11, further comprising:
checking whether the virtual machine that is once estimated as short-lived is actually short-lived or actually not short-lived after execution of the virtual machine; and
adjusting at least one of the multiple criteria responsive to the virtual machine being actually not short-lived.

14. The computer program product of claim 11, wherein the multiple criteria further include an operator of queries on the virtual machine.

15. The computer program product of claim 11, wherein the multiple criteria further include a number of executing threads on the virtual machine.

16. The computer program product of claim 11, wherein the multiple criteria further include one or more settings of the parallel distributed computing framework.

17. The computer program product of claim 16, wherein the one or more settings of the parallel distributed computing framework include whether or not a thrift server is used.

18. The computer program product of claim 11, wherein the lightweight Just In Time compilation is without profiling.

19. The computer program product of claim 11, wherein the lightweight Just In Time compilation is selected from a plurality of Just In Time compilation levels.

20. The computer program product of claim 19, wherein each of the plurality of Just In Time compilation levels correspond to a respective one of a plurality of compilation levels, the plurality of compilation levels requiring more compilation time with each increasing one of the plurality of levels, and wherein the lightweight Just In Time compilation that is selected corresponds to a lowest one of the plurality of compilation levels.
